(19) United States
(12) Patent Application Publication
(10) Pub. No.: US 2010/0020574 A1
(43) Pub. Date: Jan. 28, 2010

(54) Power Adapter and Conversion Method

(75) Inventor: Chun-Wei Ko, Taipei (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: PEGATRON CORPORATION, Taipei (TW)

(21) Appl. No.: 12/510,941

(22) Filed: Jul. 28, 2009

(30) Foreign Application Priority Data
Jul. 27, 2008 (TW) 97128704

(51) Int. Cl. H02M 1/12

(52) U.S. Cl. 363/44

(57) ABSTRACT

A power adapter and conversion method for converting an alternating voltage to a direct voltage supplied to a load are provided. The power conversion method includes the following steps. The alternating voltage is received and filtered to generate a filter voltage. The filter voltage is received and rectified to generate a rectified voltage. A bulk capacitor is provided for receiving the rectified voltage to generate an output voltage. A transformer having a primary side and a secondary side is provided. The primary side is coupled to a bulk capacitor to receive the output voltage. The secondary side generates the direct voltage and is coupled to the load. The alternating voltage is detected. When the alternating voltage is greater than a predetermined value, a circuit between the bulk capacitor and the alternating voltage is broken.

### CROSS-REFERENCE TO RELATED APPLICATIONS

This Non-provisional application claims priority under 35 U.S.C. §119(a) on Patent Application No(s). 97128704 filed in Taiwan, Republic of China on Jul. 29, 2008, the entire contents of which are hereby incorporated by reference.

### BACKGROUND OF THE INVENTION

1. Field of the Invention

The invention relates to a power adapter and conversion method and, more particularly, to a power adapter and conversion method having overvoltage protection.

2. Description of the Related Art

A computer system, such as a notebook computer, converts commercial power which is an alternating voltage to a direct voltage needed by the computer system after by a power adapter. In the prior art, according to feedback from selling markets of electronic products, the computer systems are often returned due to the damaged power adapters of the computer systems. Analyses indicate that bulk capacitors of the power adapters are burned out in the most circumstances and the circumstances are centralized in the areas where power distribution systems are unstable and the commercial power is higher, such as China, India and so on. The power adapter needs to receive the commercial power. Therefore, when the commercial power is unstable, if a voltage of the received commercial power suddenly increases to exceed a withstand voltage of the bulk capacitor, the bulk capacitor may be burned out, further to damage the power adapter.

In addition, when a power plug of the power adapter is connected with a socket of the commercial power, since the bulk capacitor is in a short-circuit state at the moment when the power plug is connected with the socket, a higher inrush current is generated. Since a greater inrush current is generated at the moment when the power plug is connected with the socket, sparks are generated instantaneously. Thus, users may feel dangerous. Further, the power plug of the power adapter may be corroded by the sparks, thereby damaging the power plug.

### BRIEF SUMMARY OF THE INVENTION

This invention provides a power adapter and conversion method. According to the power adapter and conversion method provided by the invention, when a voltage of commercial power is higher, the commercial power stops being supplied to the power adapter. Thus, a bulk capacitor will be prevented from being burned out due to the higher voltage of the commercial power. In addition, at the moment when the power adapter is connected with the commercial power, the commercial power doesn't directly entering into the bulk capacitor at that moment. Thus, the problem that sparks are generated instantaneously can be solved.

The embodiment of the invention provides a power adapter for converting an alternating voltage to a direct voltage supplied to a load. The power adapter includes a filter circuit, a rectifier circuit, a bulk capacitor, a transformer, and an overvoltage protection (OVP) circuit. The filter circuit receives the alternating voltage and filters the alternating voltage to generate a filter voltage. The rectifier circuit is coupled to the filter circuit, and the rectifier circuit receives the filter voltage and rectifies the filter voltage to generate a rectified voltage. The bulk capacitor is coupled to the rectifier circuit and receives the rectified voltage to output an output voltage. The transformer has a primary side and a secondary side. The primary side is coupled to the bulk capacitor to receive the output voltage, and the secondary side generates the direct voltage and is coupled to the load. The overvoltage protection circuit is coupled between the filter circuit and the bulk capacitor. When the alternating voltage is greater than a predetermined value, the overvoltage protection circuit is closed, such that the circuit between the bulk capacitor and the alternating voltage is broken.

The embodiment of the invention also provides a power conversion method for converting an alternating voltage to a direct voltage supplied to a load. The method includes the following steps. The alternating voltage is received, and the alternating voltage is filtered to generate a filter voltage. The filter voltage is received, and the filter voltage is rectified to generate a rectified voltage. A bulk capacitor is provided for receiving the rectified voltage to generate an output voltage. A transformer having a primary side and a secondary side is provided. The primary side is coupled to the bulk capacitor to receive the output voltage, and the secondary side generates the direct voltage and is coupled to the load. The alternating voltage is detected. When the alternating voltage is greater than a predetermined value, the circuit between the bulk capacitor and the alternating voltage is broken.

These and other features, aspects, and advantages of the present invention will become better understood with regard to the following description, appended claims, and accompanying drawings.

### BRIEF DESCRIPTION OF THE DRAWINGS

FIG. 1 is a schematic diagram showing a power adapter according to a first embodiment of the invention;

FIG. 2 is a schematic diagram showing a power adapter according to a second embodiment of the invention;

FIG. 3 is a schematic diagram showing a power adapter according to a third embodiment of the invention;

FIG. 4 is a schematic diagram showing a power adapter according to a fourth embodiment of the invention;

FIG. 5 is a schematic diagram showing a power adapter according to a fifth embodiment of the invention; and

FIG. 6 is a flowchart showing a power conversion method according to one embodiment of the invention.

### DETAILED DESCRIPTION OF THE INVENTION

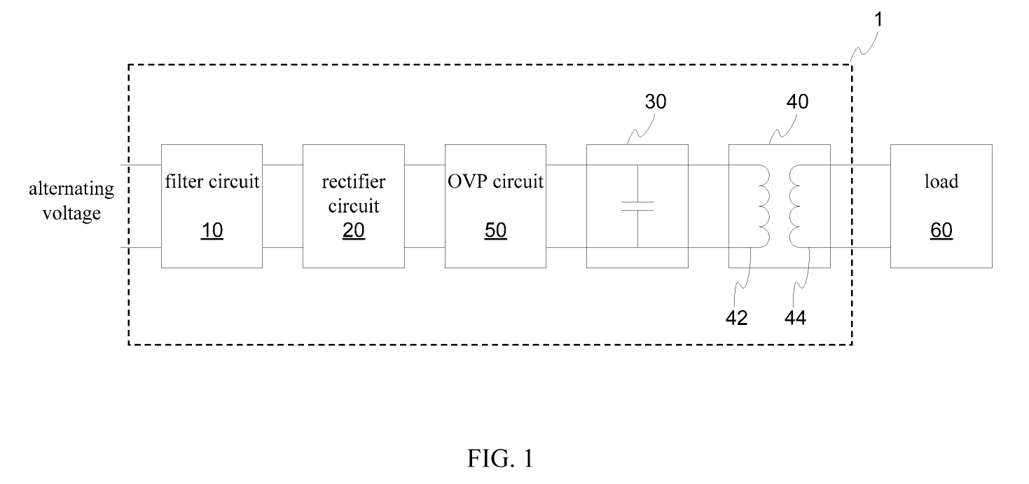

FIG. 1 is a schematic diagram showing a power adapter according to a first embodiment of the invention. Please refer to FIG. 1. A power adapter 1 provided by the embodiment of the invention converts an alternating voltage to a direct voltage supplied to a load 60. The power adapter 1 includes a filter circuit 10, a rectifier circuit 20, a bulk capacitor 30, a transformer 40, and an overvoltage protection (OVP) circuit 50.

The filter circuit 10 receives the alternating voltage provided by commercial power and generates a filter voltage after filtering the alternating voltage. The filter circuit 10 may be a RC filter or an LC filter and so on. However, the invention is not limited thereto. The rectifier circuit 20 is coupled to the filter circuit 10, and the rectifier circuit 20 receives the filter voltage transmitted by the filter circuit 10 and generates a rectified voltage after rectifying the filter voltage. The rectifier circuit 20 may be a half-wave rectifier or a full-wave rectifier. The rectifier circuit 20 can achieve a rectifying effect with a diode having a characteristic that the diode is turned on in one direction and is turned off in the opposite direction. However, the invention is not limited thereto.

The bulk capacitor 30 is coupled to the rectifier circuit 20 and receives the rectified voltage transmitted by the rectifier circuit 20 to generate an output voltage. Since the capacitor is an energy storing element, during the rectifying period of the rectifier circuit 20, that is, when a diode of the rectifier circuit 20 is turned on, the bulk capacitor 30 can be charged and store electric charges at the same time. At that moment, if the bulk capacitor 30 is not arranged, when the diode of the rectifier circuit 20 is turned off or the voltage decreases, the generated voltage also decreases, thereby forming a called ripple voltage instead of a stable direct voltage. Therefore, via the bulk capacitor 30, when the diode of the rectifier circuit 20 is turned off or the voltage decreases, the bulk capacitor 30 discharges, thus to slow the decrease of the voltage. Therefore, the bulk capacitor 30 arranged in the power adapter 1 can be used to reduce the effect of the ripple to the circuit, thus to obtain the stable output voltage. Further, the voltage supplied to the load 60 is a stable direct voltage.

The transformer 40 has a primary side 42 and a secondary side 44. The primary side 42 is coupled to the bulk capacitor 30, and the secondary side 44 is coupled to the load 60. The transformer 40 receives the output voltage generated by the bulk capacitor 30 to generate the direct voltage needed by the load 60.

The overvoltage protection circuit 50 is coupled between the filter circuit 10 and the bulk capacitor 30. When the alternating voltage is greater than a predetermined value, the overvoltage protection circuit 50 is closed, such that the circuit between the bulk capacitor 30 and the alternating voltage is broken. According to the above, the overvoltage protection circuit 50 is located at the primary side 42 of the transformer 40, and it is mainly used for protecting the bulk capacitor 30. Thereby, the bulk capacitor 30 does not increase suddenly thus to be burned out by the instability of the alternating voltage. However, in the prior art, the overvoltage protection circuit is mostly located at the secondary side of the transformer to protect the load, which is different from this embodiment.

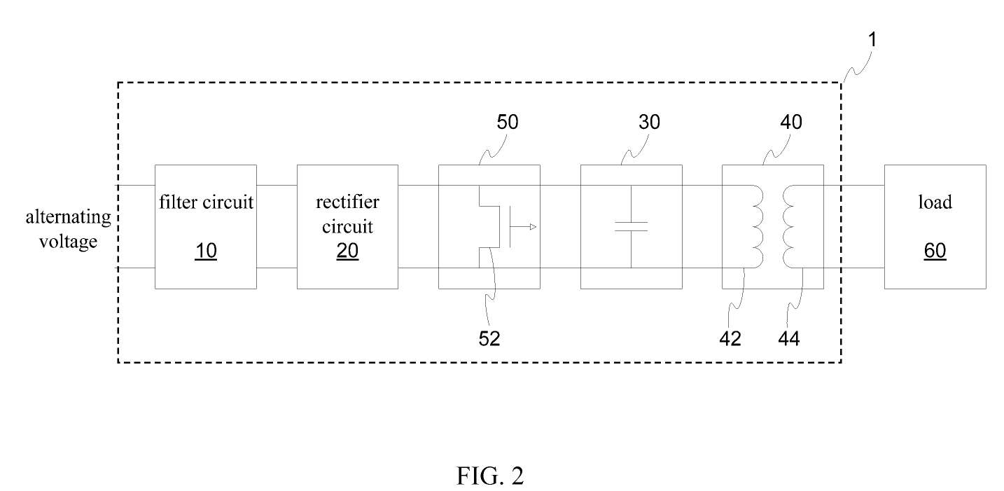

FIG. 2 is a schematic diagram showing a power adapter according to a second embodiment of the invention. In this embodiment, the overvoltage protection circuit 50 can include a MOS transistor switch 52. The MOS transistor switch 52 may be a high-voltage MOS transistor, thus affording a higher voltage to protect the bulk capacitor 30. When the alternating voltage is less than a predetermined value, that is, in a normal state, the MOS transistor switch 52 is turned on. Therefore, the alternating voltage can be smoothly converted to the direct voltage supplied to the load 60. Relatively, when the alternating voltage suddenly increases to make the voltage greater than the predetermined value, the MOS transistor switch 52 is turned off. Thus, the higher alternating voltage fails to flow to the bulk capacitor 30, and the bulk capacitor 30 can be prevented from being burned out by the higher voltage. The predetermined value may be a maximum withstand voltage of the bulk capacitor 30. Therefore, before the alternating voltage exceeds the maximum withstand voltage of the bulk capacitor 30, the overvoltage protection circuit 50 makes the circuit between the bulk capacitor 30 and the alternating voltage broken, thus to protect the bulk capacitor 30.

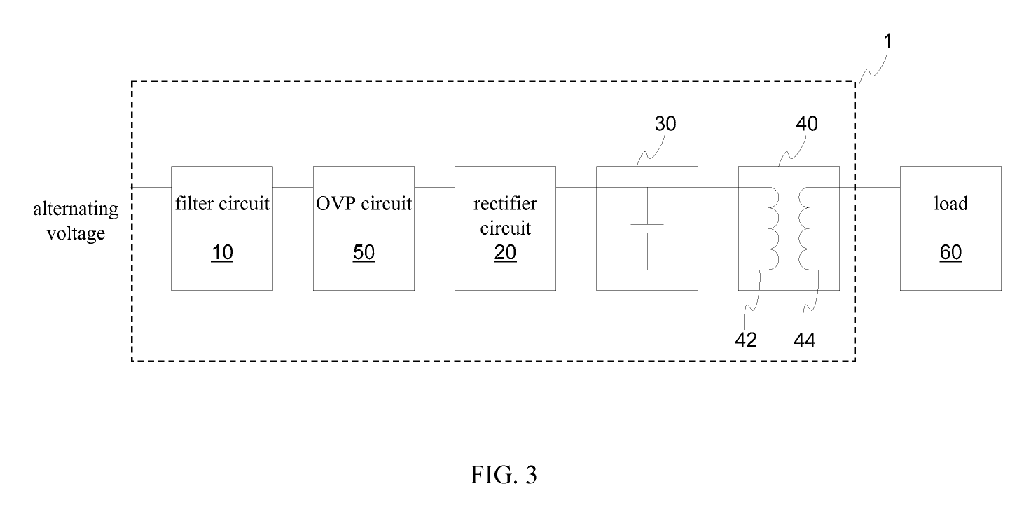

FIG. 3 is a schematic diagram showing a power adapter according to a third embodiment of the invention. Since the overvoltage protection circuit 50 can be coupled between the filter circuit 10 and the bulk capacitor 30, in FIG. 1, one terminal of the overvoltage protection circuit 50 is coupled to the rectifier circuit 20, and the other terminal is coupled to the bulk capacitor 30. However, in FIG. 3, one terminal of the overvoltage protection circuit 50 is coupled to the filter circuit 10, and the other terminal is coupled to the rectifier circuit 20. In the two different coupling modes, the overvoltage protection circuit 50 can protect the bulk capacitor 30.

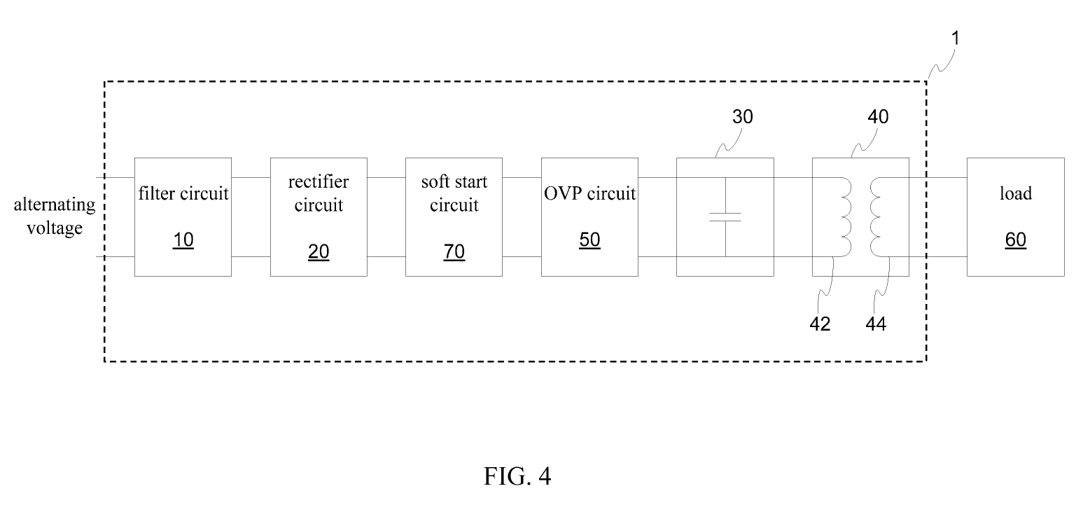

FIG. 4 is a schematic diagram showing a power adapter according to a fourth embodiment of the invention. In the fourth embodiment, the power adapter 1 can further include a soft start circuit 70. In this embodiment, the soft start circuit 70 can be coupled between the filter circuit 10 and the bulk capacitor 30 for slowly increasing the alternating voltage.

At the moment when the power adapter 1 is connected to the alternating voltage, the generated input current is equal to the alternating voltage dividing an equivalent resistance on the input route (I=V/R). Since the bulk capacitor 30 is almost in a short-circuit state at the moment when the power adapter 1 is connected to the alternating voltage, and the resistances of the filter circuit 10 and the rectifier circuit 20 are small, the momentary input current is so great. Therefore, when the power plug of the power adapter 1 is connected with a commercial power plug (the alternating voltage), sparks are easily generated instantaneously. Therefore, in the embodiment of the invention, the soft start circuit 70 is disposed in the power adapter 1. At the moment when the alternating voltage enters into the power adapter 1, the voltage can slowly increase. Thus, the greater momentary input current can be avoided, further to avoid generating sparks.

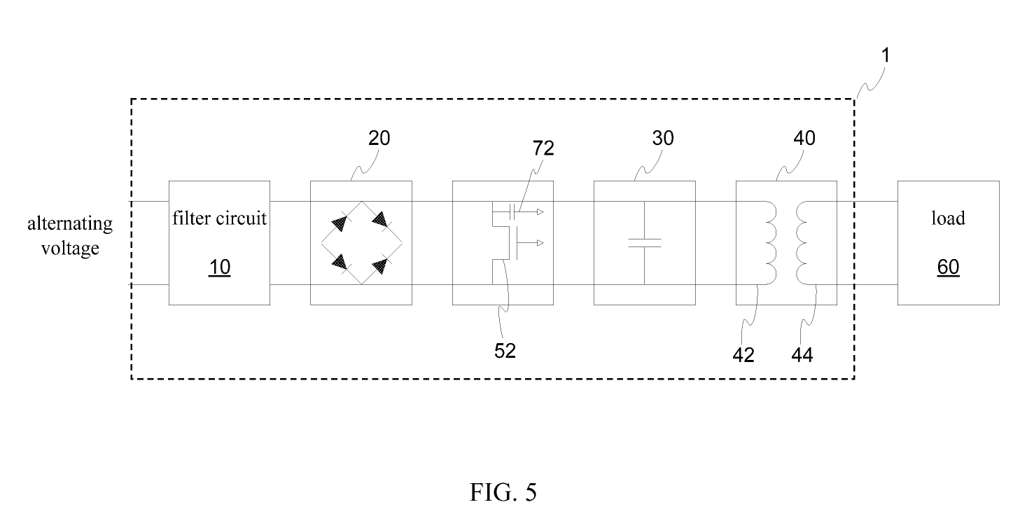

FIG. 5 is a schematic diagram showing a power adapter according to a fifth embodiment of the invention. To save cost, the soft start circuit 70 can be coupled to the overvoltage protection circuit 50. The simple method is to make the MOS transistor switch 52 coupled to the capacitor 72. Since the MOS transistor switch 52 can be turned on or off in proper states according to the above, the overvoltage protection can be achieved. Further, the capacitor 72 can store electric charges. At the moment when the alternating voltage is input, it slowly charges the capacitor 72. In cooperation with the MOS transistor switch 52, a soft start function of the alternating voltage can be achieved thus to slowly increase the alternating voltage. In addition, in FIG. 5, the rectifier circuit 20 is a bridge rectifier.

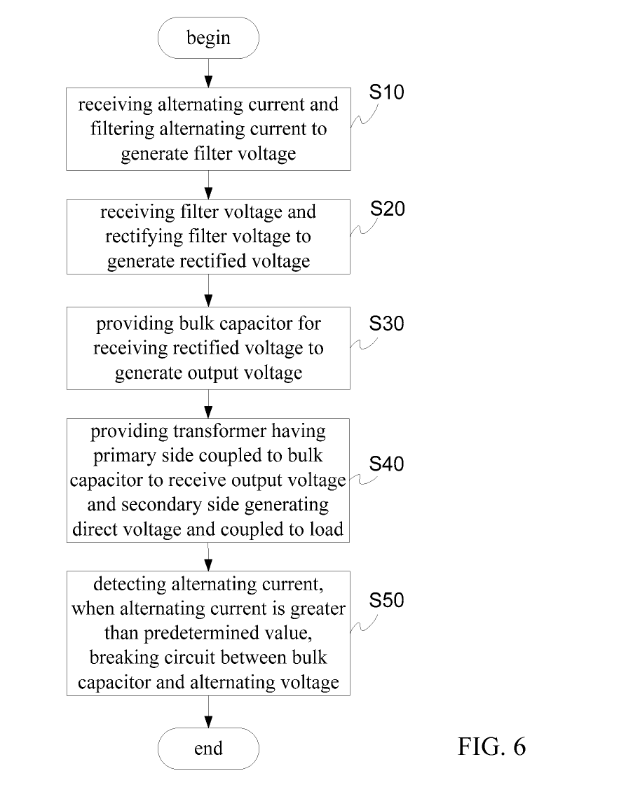

FIG. 6 is a flowchart showing a method for converting an alternating voltage to a direct voltage supplied to a load. The method includes the following steps.

Step S10: Receiving the alternating voltage and filtering the alternating voltage to generate a filter voltage.

Step S20: Receiving the filter voltage and rectifying the filter voltage to generate a rectified voltage.

Step S30: Providing a bulk capacitor for receiving the rectified voltage to generate an output voltage.

Step S40: Providing a transformer having a primary side and a secondary side. The primary side is coupled to the bulk capacitor to receive the output voltage. The secondary side generates the direct voltage and is coupled to the load.

Step S50: Detecting the alternating voltage. When the alternating voltage is greater than a predetermined value, the circuit between the bulk capacitor and the alternating voltage is broken. This step further includes the following step. A MOS transistor switch is provided to be coupled between the alternating voltage and the bulk capacitor. When the alternating voltage is less than the predetermined value, the MOS transistor switch is turned on. Relatively, when the alternating voltage is greater than the predetermined value, the MOS transistor switch is turned off. In this embodiment, the predetermined value can be a maximum withstand voltage of the bulk capacitor.

Besides the above steps, the method further includes the following steps. During a preliminary starting stage of the alternating voltage, the alternating voltage slowly increases. That is, the alternating voltage can slowly increase, and the alternating voltage does not suddenly increase to a specific value in the preliminary starting stage. Thus, the problem that sparks are easily generated at the moment when the alternating voltage is input can be solved.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A power adapter for converting an alternating voltage to a direct voltage supplied to a load, the power adapter comprising:
a filter circuit receiving the alternating voltage and filtering the alternating voltage to generate a filter voltage;
a rectifier circuit coupled to the filter circuit, the rectifier circuit receiving the filter voltage and rectifying the filter voltage to generate a rectified voltage;
a bulk capacitor coupled to the rectifier circuit and receiving the rectified voltage to generate an output voltage;
a transformer having a primary side and a secondary side, the primary side coupled to the bulk capacitor to receive the output voltage, the secondary side generating the direct voltage and coupled to the load; and
an overvoltage protection (OVP) circuit coupled between the filter circuit and the bulk capacitor, when the alternating voltage is greater than a predetermined value, the overvoltage protection circuit being closed, such that the circuit between the bulk capacitor and the alternating voltage is broken.

2. The power adapter according to claim 1, wherein the overvoltage protection circuit comprises a MOS transistor switch.

3. The power adapter according to claim 2, wherein when the alternating voltage is less than the predetermined value, the MOS transistor switch is turned on, and when the alternating voltage is greater than the predetermined value, the MOS transistor switch is turned off.

4. The power adapter according to claim 1, wherein the predetermined value is a maximum withstand voltage of the bulk capacitor.

5. The power adapter according to claim 1, wherein one terminal of the overvoltage protection circuit is coupled to the filter circuit, and the other terminal is coupled to the rectifier circuit.

6. The power adapter according to claim 1, wherein one terminal of the overvoltage protection circuit is coupled to the rectifier circuit, and the other terminal is coupled to the bulk capacitor.

7. The power adapter according to claim 1, further comprising:
a soft start circuit, coupled between the filter circuit and the bulk capacitor, for slowly increasing the alternating voltage.

8. The power adapter according to claim 7, wherein the soft start circuit comprises a capacitor.

9. The power adapter according to claim 7, wherein the soft start circuit is coupled to the overvoltage protection circuit by coupling a capacitor to a MOS transistor switch.

10. The power adapter according to claim 1, wherein the rectifier circuit is a bridge rectifier.

11. A power conversion method for converting an alternating voltage to a direct voltage supplied to a load, the method comprising the steps of:
receiving the alternating voltage and filtering the alternating voltage to generate a filter voltage;
receiving the filter voltage and rectifying the filter voltage to generate a rectified voltage;
providing a bulk capacitor for receiving the rectified voltage to generate an output voltage;
providing a transformer having a primary side and a secondary side, the primary side coupled to the bulk capacitor to receive the output voltage, the secondary side generating the direct voltage and coupled to the load; and
detecting the alternating voltage, when the alternating voltage is greater than a predetermined value, breaking the circuit between the bulk capacitor and the alternating voltage.

12. The power conversion method according to claim 11, wherein the step of breaking the circuit between the alternating voltage and the bulk capacitor further comprises the step of:
providing a MOS transistor switch coupled between the alternating voltage and the bulk capacitor.

13. The power conversion method according to claim 12, further comprising the steps of:
turning on the MOS transistor switch when the alternating voltage is less than the predetermined value; and
turning off the MOS transistor switch when the alternating voltage is greater than the predetermined value.

14. The power conversion method according to claim 11, wherein the predetermined value is a maximum withstand voltage of the bulk capacitor.

15. The power conversion method according to claim 11, further comprising the step of:
slowly increasing the alternating voltage during a preliminary starting stage of the alternating voltage.
